(19) United States
(12) Patent Application Publication
(10) Pub. No.: US 2026/0266092 A1
(43) Pub. Date: Sep. 10, 2026

(54) COMBINATION LOCK WITH DUAL UNLOCKING MODES

(71) Applicant: SINOX COMPANY LTD., New Taipei City (TW)

(72) Inventors: Kuo-Kuang PAN, New Taipei City (TW); Chien-Hung WU, New Taipei City (TW)

(73) Assignee: SINOX COMPANY LTD., New Taipei City (TW)

(21) Appl. No.: 19/211,562

(22) Filed: May 19, 2025

(30) Foreign Application Priority Data
Mar. 10, 2025 (TW) 114202400

(51) Int. Cl. E05B 37/02; E05B 73/00

(52) U.S. Cl. CPC E05B 37/025; E05B 73/0082

(57) ABSTRACT

A combination lock comprises a shell, number wheel sets rotatably mounted to the shell, a lock rod movably mounted in the shell through the number wheel sets, a linkage assembly movably or rotatably mounted in the shell and connected to the number wheel sets, an operating member connected to the linkage assembly, and an output assembly connected to the lock rod and the operating member and having an unlocked state and a locked state. When being rotated to a user code, the number wheel sets allow the lock rod to move relative to it for switching the output assembly to the unlocked state. When the number wheel sets are rotated to a master code, the operating member is moveable or rotatable by the user to move or rotate the linkage assembly relative to the number wheel sets for switching the output assembly to the unlocked state.

### BACKGROUND OF THE INVENTION

### 1. Field of the Invention

The present invention relates to a combination lock, and more particularly to a variety of combination locks such as a portable electronic device lock, a cabinet lock, a padlock, etc.

### 2. Description of the Prior Arts

Nowadays, many apparatuses or devices use combination locks for anti-theft purposes, for example, a laptop lock, a cabinet lock for lockers in a mall, etc.

However, a conventional combination lock is designed with a single set of code, so a user cannot unlock the conventional combination lock if the user forgets the code. More particularly, when the conventional combination lock is locked on apparatuses or devices, the user will be unable to take away his own laptop or to open up a door of a cabinet, which causes huge trouble. Therefore, the conventional combination lock needs improvement.

To overcome the shortcomings, the present invention provides a combination lock with dual unlocking modes.

### SUMMARY OF THE INVENTION

The main objective of the present invention is to provide a combination lock with dual unlocking modes. The combination lock can be unlocked with two different sets of codes corresponding to two unlocking modes. Therefore, even if a user forgets the code of the combination lock, the user may still acquire the other set of code to unlock.

The combination lock with dual unlocking modes comprises a shell, multiple number wheel sets, a lock rod, a linkage assembly, an operating member, and an output assembly. The multiple number wheel sets are rotatably mounted to the shell and are rotatable by a user. The lock rod is movably mounted in the shell and through the multiple number wheel sets. The linkage assembly is movably or rotatably mounted in the shell and is connected to the multiple number wheel sets. The operating member is operable by the user and is connected to the linkage assembly. The output assembly is connected to the lock rod and the operating member, and has an unlocked state and a locked state. When the multiple number wheel sets are rotated to a user code, the multiple number wheel sets allow the lock rod to move relative to the multiple number wheel sets, so as to switch the output assembly to the unlocked state. When the multiple number wheel sets are rotated to a master code, the operating member is moveable or rotatable by the user to move or rotate the linkage assembly relative to the multiple number wheel sets, so as to switch the output assembly to unlocked state.

Another combination lock with dual unlocking modes comprises a shell, multiple number wheel sets, a lock rod, a linkage assembly, an operating member, and an output assembly. The multiple number wheel sets are rotatably mounted to the shell and are rotatable by a user. The lock rod is movably mounted in the shell and through the multiple number wheel sets. The linkage assembly is movably or rotatably mounted in the shell and is connected to the multiple number wheel sets. The operating member is operable by the user and is connected to the linkage assembly and one of the multiple number wheel sets. The output assembly is connected to the lock rod and has an unlocked state and a locked state. When the multiple number wheel sets are rotated to a user code, the multiple number wheel sets allow the lock rod to move relative to the multiple number wheel sets, so as to switch the output assembly to the unlocked state. When the multiple number wheel sets are rotated to a master code, the operating member is moveable or rotatable by the user to move or rotate the linkage assembly relative to the multiple number wheel sets, so as to allow the multiple number wheel sets and the lock rod to move together and switch the output assembly to the unlocked state.

The advantage of the present invention is that when in use, the user originally only knows the user code, and only when all the number wheel sets are rotated to the user code can the lock rod move relative to the number wheel sets to switch the output assembly to the unlocked state for unlocking. When the user inadvertently loses the user code, the master code can be acquired from the management personnel (e.g. of a lock manufacturer or a mall). By setting all the number wheel sets to the master code, the user can operate the operating member to switch the output assembly to the unlocked state for unlocking. The present invention thereby has two modes with two different codes to unlock, so even if the user forgets the code, unlocking is still possible through another set of the codes.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a combination lock with dual unlocking modes in accordance with the present invention;

FIG. 2 shows the combination lock in FIG. 1 with a shell partially omitted;

FIGS. 3 to 5 are exploded views of the combination lock in FIG. 1;

FIG. 6 is a cross-sectional side view of the combination lock in FIG. 1;

FIGS. 7 to 9 are operational cross-sectional top views of the combination lock in FIG. 1;

FIGS. 10 and 11 are operational top views of the combination lock in FIG. 1 with the shell partially omitted;

FIG. 12 is a cross-sectional rear side view of the combination lock in FIG. 1;

FIG. 13 is a top view of a second embodiment of a combination lock with dual unlocking modes in accordance with the present invention;

FIG. 14 is an operational side view of the combination lock in FIG. 12;

FIG. 15 is a view of a third embodiment of a combination lock with dual unlocking modes in accordance with the present invention, with a shell partially omitted;

FIG. 16 is an exploded view of the combination lock in FIG. 15;

FIGS. 17 and 18 are operational cross-sectional front side views of the combination lock in FIG. 15;

FIGS. 19 and 20 are operational cross-sectional front side views viewed from another angle of the combination lock in FIG. 15;

FIG. 21 is a schematic view of a fourth embodiment of a combination lock with dual unlocking modes in accordance with the present invention;

FIG. 22 is an operational schematic view of the combination lock in FIG. 21, illustrating unlocking with a user code; and

FIG. 23 is another operational schematic view of the combination lock in FIG. 21, illustrating unlocking with a master code.

### DETAILED DESCRIPTION OF THE PREFERRED EMBODIMENTS

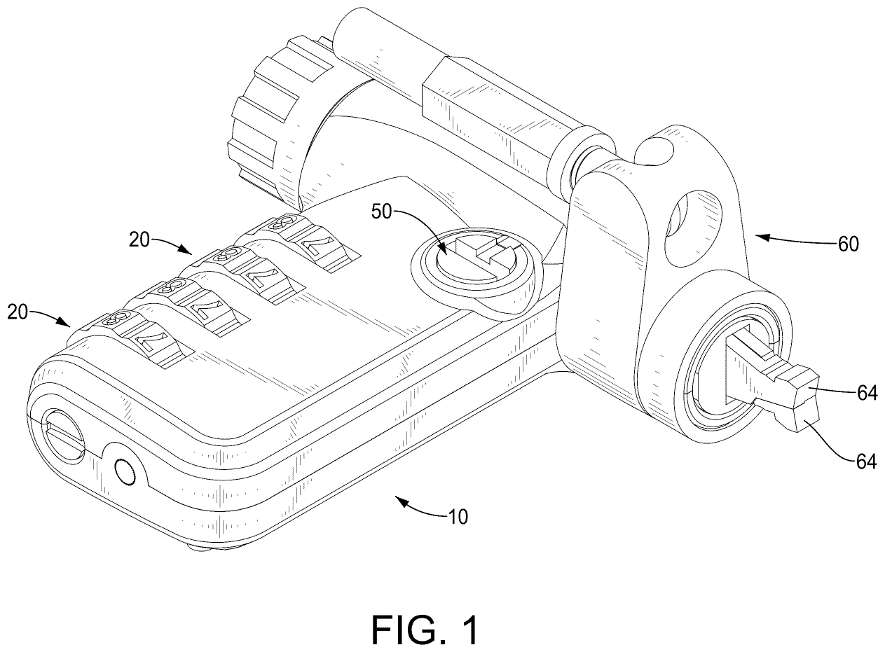

A combination lock with dual unlocking modes in accordance with the present invention comprises two configurations, wherein the first configuration includes a first embodiment to a third embodiment, and the second configuration includes the fourth embodiment. With reference to FIGS. 1 to 3, the first configuration comprises a shell 10, multiple number wheel sets 20, a lock rod 30, a linkage assembly 40, an operating member 50, and an output assembly 60.

The shell 10 has multiple through holes for exposing the number wheel sets 20 and the operating member 50.

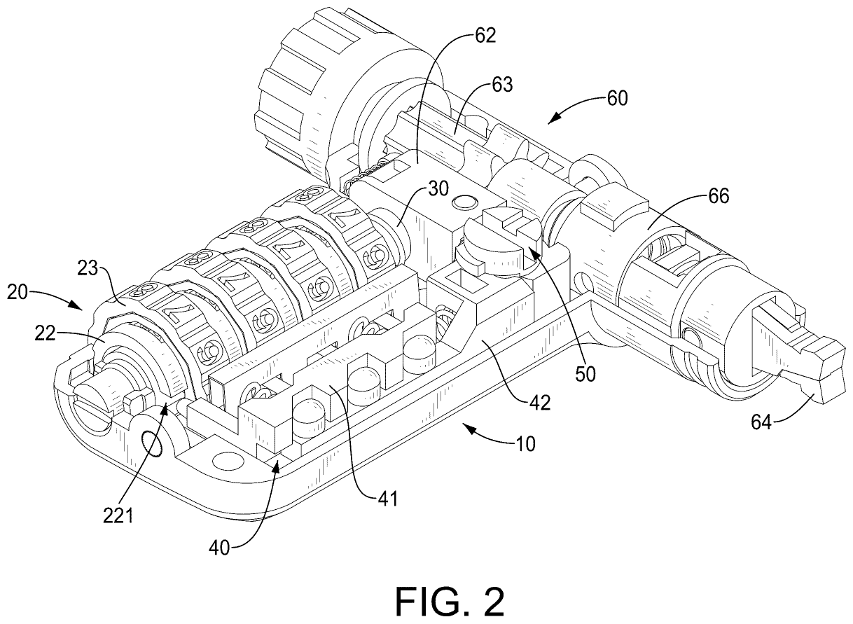

With reference to FIGS. 2 to 4 and 7, the multiple number wheel sets 20 are rotatably mounted to the shell 10 and are rotatable by a user. In the present embodiment, each multiple number wheel set 20 comprises an inner sheath 21, an outer sheath 22, and a number wheel 23. The inner sheath 21 is disposed through the outer sheath 22, and the outer sheath 22 is disposed through the number wheel 23. The number wheel 23 is exposed from the shell 10 and is the member which is rotated by the user. When the user rotates the number wheel 23, the number wheel 23 drives the outer sheath 22 and the inner sheath 21 to rotate simultaneously. The number wheel 23, the outer sheath 22, and the inner sheath 21 are mounted unrotatably to each other, while the number wheel 23, the outer sheath 22, and the inner sheath 21 can move relative to each other when necessary. The inner sheath 21 has an inner notch 211, which is preferably radially disposed on an inner surface of the inner sheath 21 and axially extends to two ends of the inner sheath 21, while other positions or shapes are also possible. The outer sheath 22 has an outer notch 221, which is preferably radially disposed on an outer surface of the outer sheath 22, while other positions or shapes are also possible.

The lock rod 30 is movably mounted in the shell 10 and is mounted through the number wheel sets 20. Preferably, the lock rod 30 is disposed through the inner sheaths 21 of the number wheel sets 20, corresponding to the inner notches 211 of the inner sheaths 21. In other words, when protrusions 31 on an outer surface of the lock rod 30 correspond to the inner notches 211 of the inner sheaths 21, the lock rod 30 can move relative to the number wheel sets 20.

With reference to FIGS. 2, 3, 7, and 9 to 11, the linkage assembly 40 is movably or rotatably mounted in the shell 10, and is connected to the number wheel sets 20. In the first embodiment, the linkage assembly 40 comprises a through member 41 and a direction-changing pushing member 42.

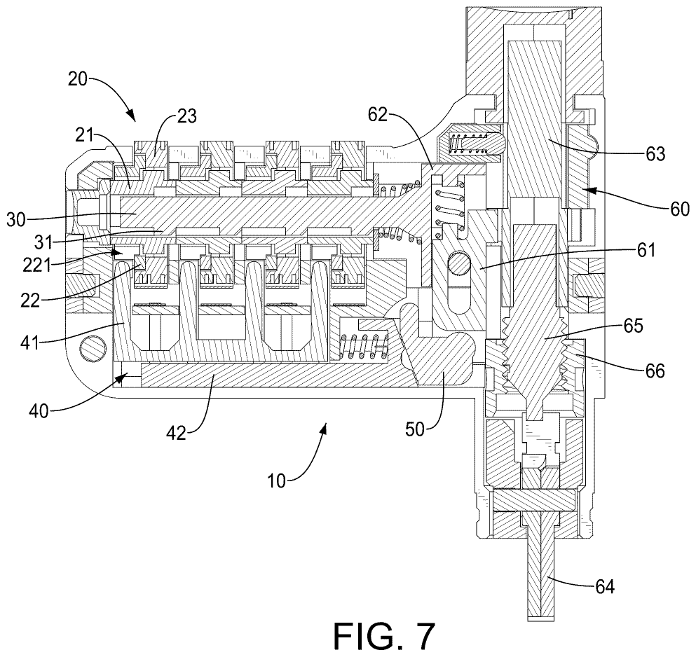

The through member 41 is movably mounted in the shell 10, is biased to move toward the direction-changing pushing member 42, and corresponds to the outer notches 221 of the outer sheaths 22 of the number wheel sets 20 (as shown in FIGS. 7 to 9). The through member 41 is preferably biased toward the direction-changing pushing member 42 by an elastic member, but two magnets repelling each other and the like are also applicable.

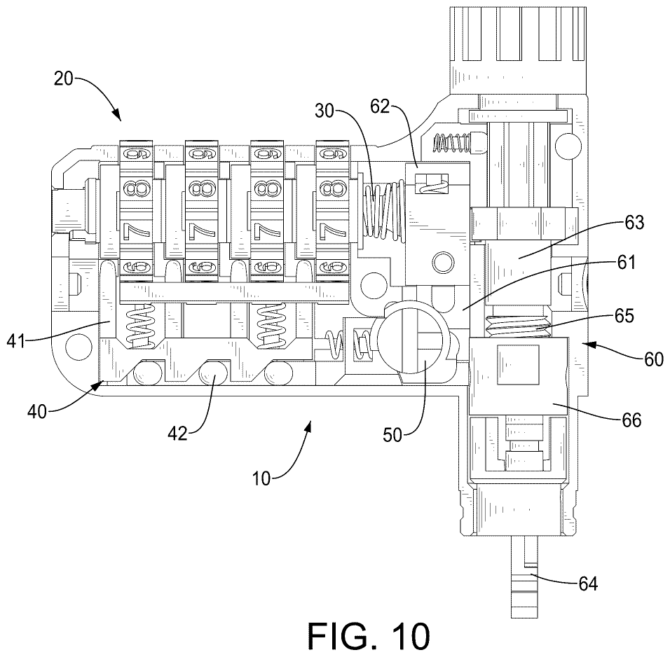

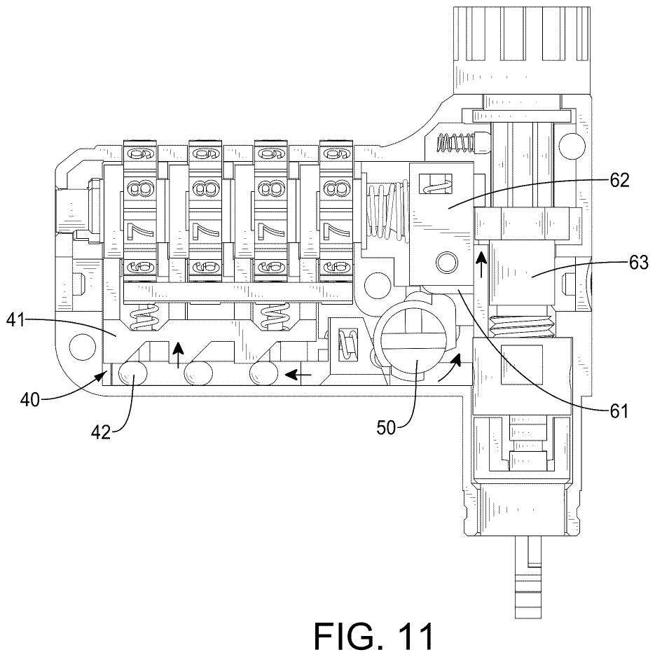

The direction-changing pushing member 42 is movably mounted in the shell 10, and is biased to move away from the through member 41 in a direction being non-parallel (preferably perpendicular) to a direction along which the through member 41 moves. With reference to FIGS. 10 and 11, the direction-changing member 42 moving toward through member 41 can push the through member 41 toward the number wheel sets 20. The direction-changing pushing member 42 is preferably biased to move away from the through member 41 by an elastic member, but two magnets repelling each other and the like are also applicable.

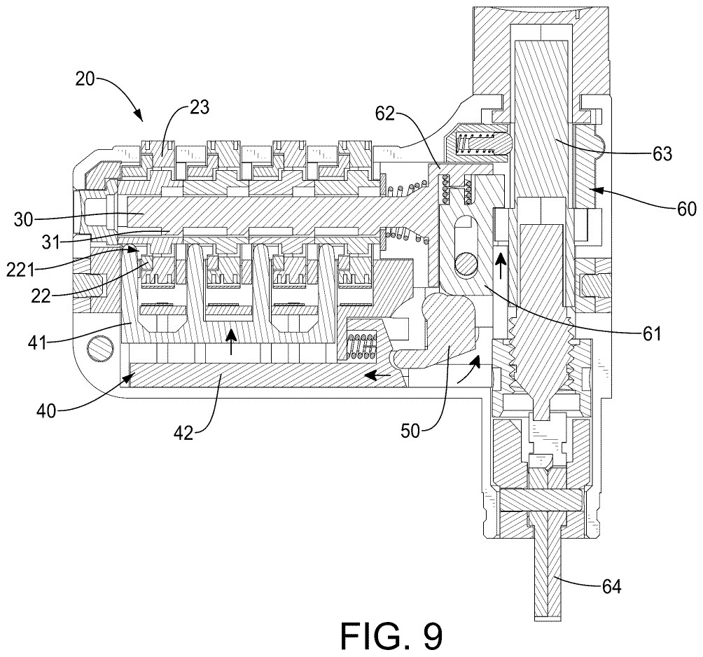

The operating member 50 is operable by the user and is connected to the linkage assembly 40. In the first embodiment, the operating member 50 is operated by rotating, but the operating member 50 can be operated by pressing or pushing as well. In the first embodiment, after being operated (rotated), the operating member 50 pushes the direction-changing pushing member 42 (with reference to FIGS. 10 to 11), further making the direction-changing pushing member 42 push the through member 41 toward the number wheel sets 20 (with reference to FIGS. 7 and 9).

Therefore, if the number wheel sets 20 are not compliant to all digits of the specific code, the through member 41 cannot move toward the number wheel sets 20, and then the direction-changing pushing member 42 cannot move toward the through member 41, eventually making the operating member 50 non-operatable (unrotatable). The direction-changing pushing member 42 is used to change the transmission direction from the operating member 50, that is, providing more options to position the operating member 50 in order to match overall spatial arrangement. In other embodiments, the direction-changing pushing member 42 may be omitted, and the operating member 50 can directly push the through member 41 toward the number wheel sets 20.

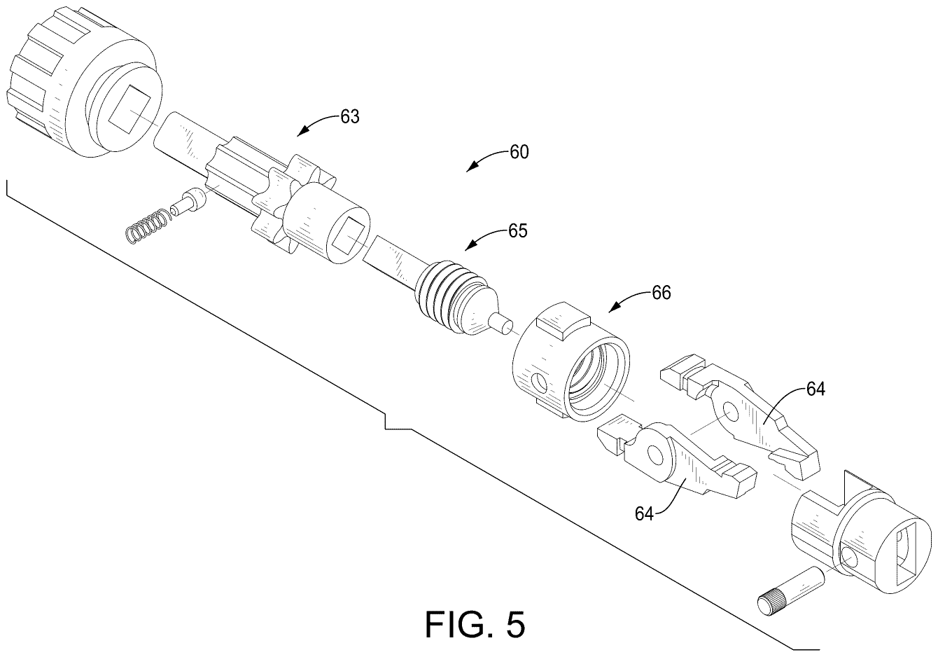

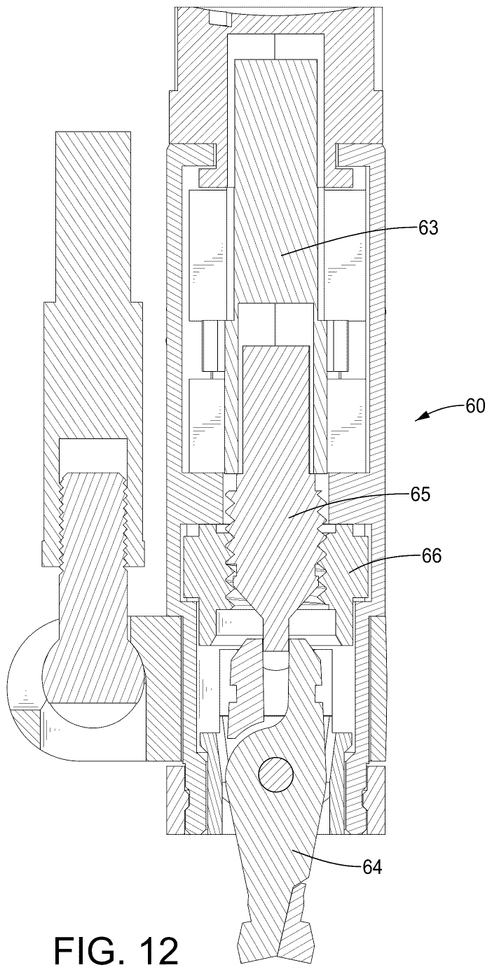

With reference to FIGS. 2, 5, 6, and 12, the output assembly 60 is connected with the lock rod 30 and the operating member 50 and has an unlocked state and a locked state. In this embodiment, the unlocked state refers to a state that the output assembly 60 can be operated by the user to unlock, but is not limited thereto. In other embodiments, the unlocked state may be a state that the output assembly 60 has been unlocked.

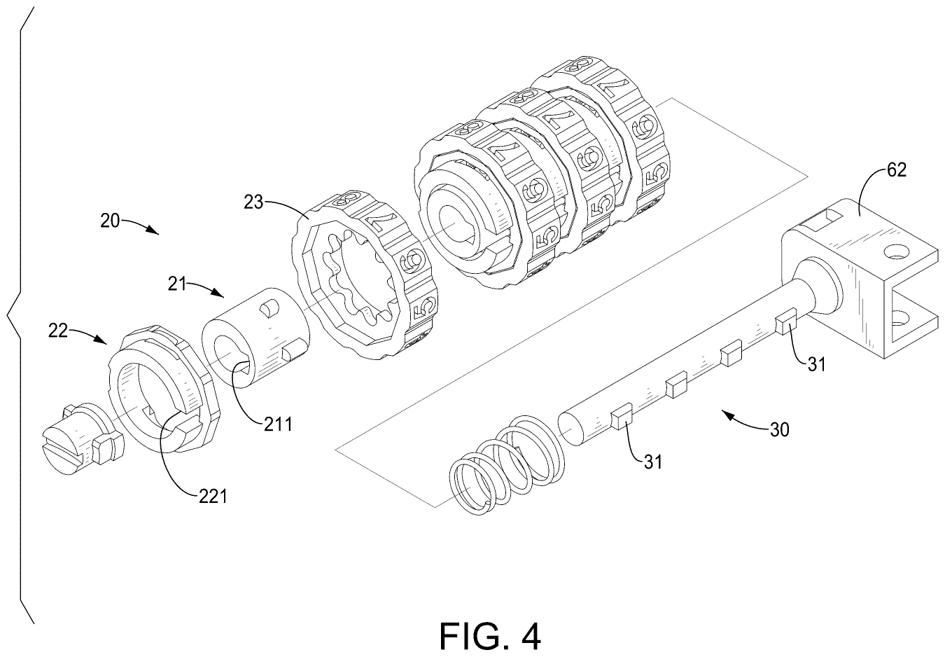

With reference to FIGS. 4, 7, and 8, when being rotated to a user code, the number wheel sets 20 allow the lock rod 30 to move relative to the number wheel sets 20, and movement of the lock rod 30 switches the output assembly 60 to the unlocked state. In this embodiment, when the number wheel sets 20 are rotated to the user code, the inner notches 211 of the inner sheaths 21 of the number wheel sets 20 are aligned, so the protrusions 31 of the lock rod 30 can pass through the inner notches 211, making the lock rod 30 movable relative to the number wheel sets 20.

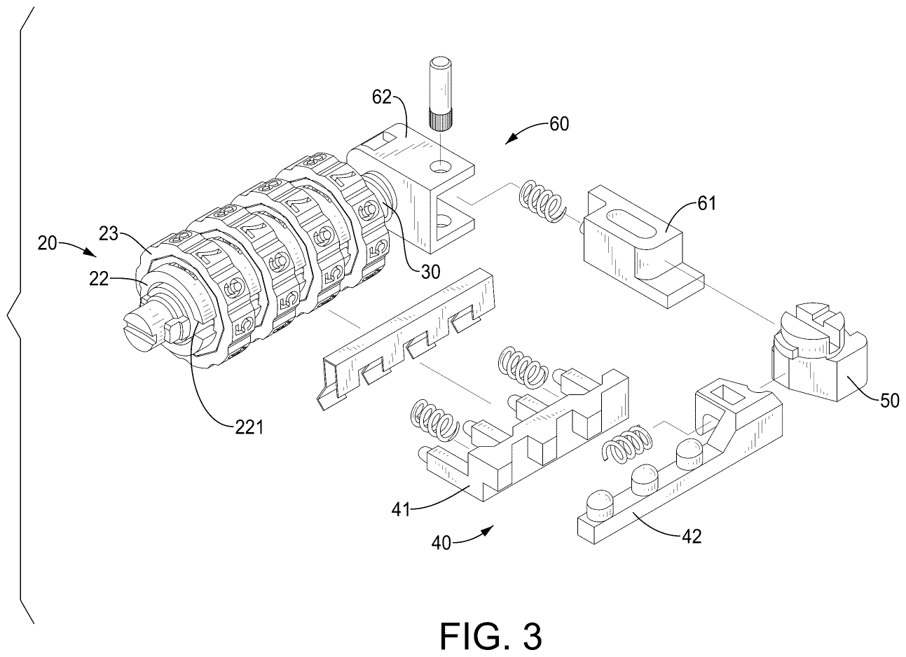

With reference to FIGS. 3, 7, and 9, when being rotated to a master code, the number wheel sets 20 allow the linkage assembly 40 to move or rotate relative to the number wheel sets 20, which further allows the operating member 50 to be moved or rotated by the user, and movement or rotation of the operating member 50 switches the output assembly 60 to the unlocked state. In other words, when the number wheel sets 20 are rotated to the master code, the operating member 50 is moveable or rotatable by the user to move or rotate the linkage assembly 40 relative to the number wheel sets 20, and movement or rotation of the operating member 50 also switches the output assembly 60 to the unlocked state.

In this embodiment, when the number wheel sets 20 are rotated to the master code, the outer notches 221 of the outer sheaths 22 of the number wheel sets 20 are aligned, so the through member 41 can enter the outer notches 221, i.e. the through member 41 can move toward the number wheel sets 20.

With reference to FIG. 3, and 7 to 9, in this embodiment, the lock rod 30 and the operating member 50 have integrated control over the output assembly 60, jointly determining whether to switch the output assembly 60 to the unlocked state. Preferably, the output assembly 60 comprises an engaging member 61, and control over the output assembly 60 is integrated on the engaging member 61.

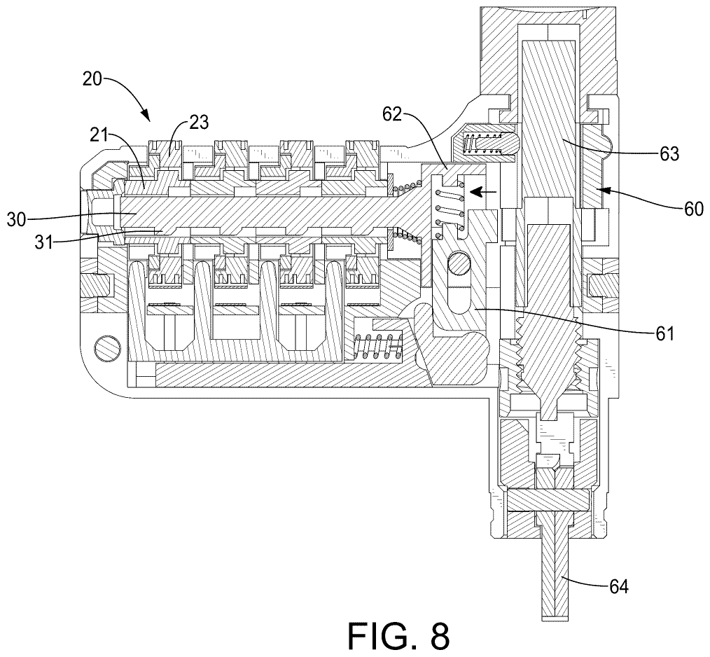

In the locked state, the engaging member 61 engages the components to make them non-operatable to unlock. With reference to FIGS. 7 to 8, when the number wheel sets 20 are rotated to the user code and the lock rod 30 moves, the lock rod 30 drives the engaging member 61 to move and thereby switches the output assembly 60 to the unlocked state. With reference to FIGS. 7 and 9, when the number wheel sets 20 are rotated to the master code and the operating member 50 is moved or rotated by the user, the operating member 50 drives the engaging member 61 to move and thereby switches the output assembly 60 to the unlocked state.

Movements of the engaging member 61 driven by the lock rod 30 and the operating member 50 may be along the same directions. However, in this embodiment, a direction along which the lock rod 30 drives the engaging member 61 to move is non-parallel to a direction along which the operating member 50 drives the engaging member 61 to move. Preferably, the two direction are perpendicular.

Specifically, the output assembly 60 further comprises a base 62 connected to and moving with the lock rod 30. The engaging member 61 is mounted on and capable of moving relative to the base 62. A direction along which the engaging member 61 moves relative to the base 62 is non-parallel, preferably perpendicular, to a direction along which the lock rod 30 moves.

Additionally, the engaging member 61 is selectively pushed by the operating member 50. In other words, the lock rod 30 pushes the base 62 and drives the engaging member 61 via the base 62 (regarded as the lock rod 30 driving the base 62 and the engaging member 61 together), and the operating member 50 directly drives the engaging member 61 (relative to the base). Both components drive the engaging member 61 toward different directions, and the both directions can make the output assembly 60 switched to the unlocked state.

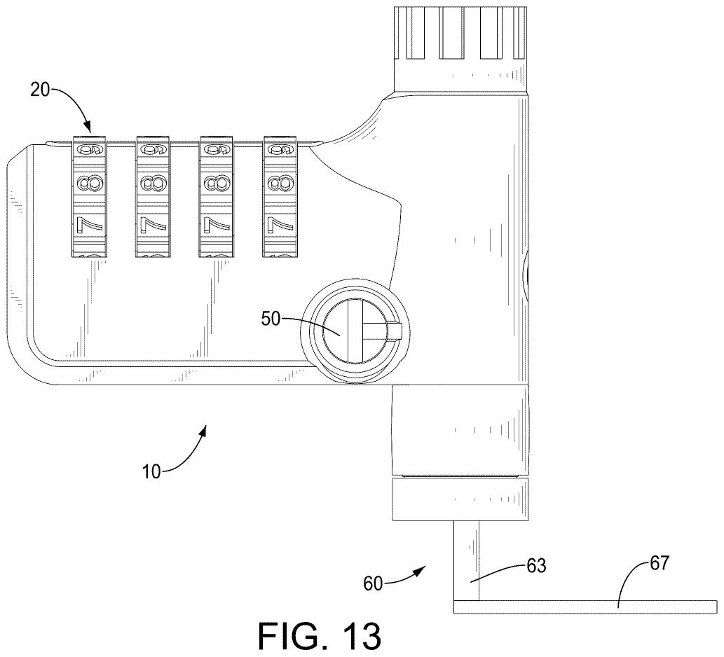

The output assembly 60 comprises structures to fix other things or to fix the combination lock of the present invention at a specific position. For instance, with reference to FIG. 1, the output assembly 60 of the first embodiment comprises two hooks 64 of a laptop lock; with reference to FIG. 13, the output assembly 60 of the second embodiment comprises a latch 67 of a cabinet lock.

With reference to FIGS. 2, 5, 6, 7, and 12, in the first and the second embodiments, the output assembly 60 comprises an output shaft 63, which is selectively engaged by the engaging member 61 and thereby is non-rotatable.

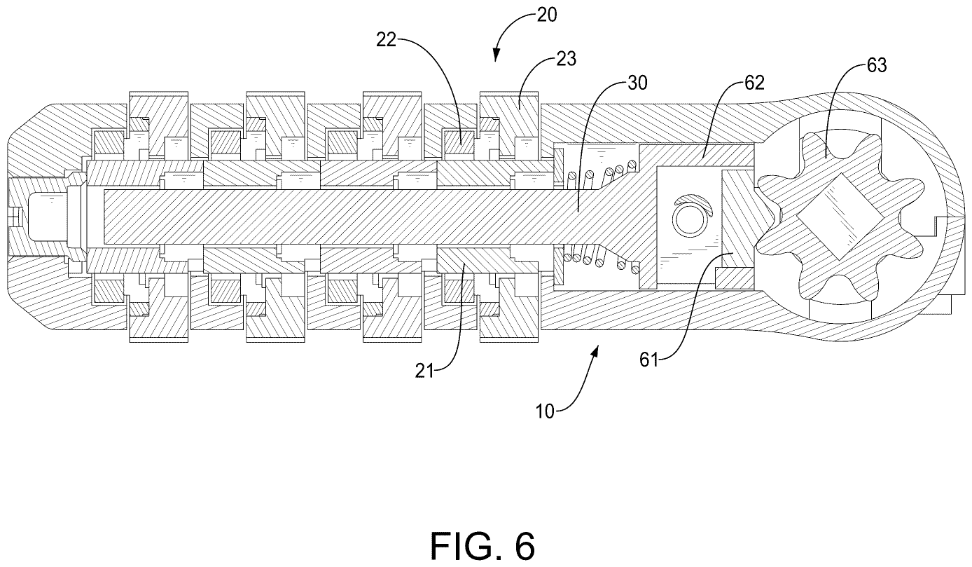

In the locked state, with reference to FIG. 6, the engaging member 61 engages the output shaft 63 and blocks the output shaft 63 from rotating.

When the number wheel sets 20 are rotated to the user code, the lock rod 30 is capable of moving away from the output shaft 63, so as to make the engaging member 61 disengage from the output shaft 63 and make the output shaft 63 rotatable. Specifically, with reference to FIGS. 7 and 8, an elastic member pushes the lock rod 30 toward the output shaft 63, and when the number wheel sets 20 are rotated to the user code, the user pulls the lock rod 30 from the output shaft 63 or directly rotates the output shaft 63 to push the lock rod 30 away.

When the number wheel sets 20 are rotated to the master code and the operating member 50 is moved or rotated by the user, the operating member 50 drives the engaging member 61 to move relative to the base 62, so as to make the engaging member 61 disengage from the output shaft 63 and make the output shaft 63 rotatable. Specifically, with reference to FIGS. 7 and 9, the engaging member 61 moves along an axial direction of the output shaft 63, and makes the engaging member 61 axially depart from where to engage the output shaft 63 so as to disengage from the output shaft 63.

The output shaft 63 can cooperate with different elements to form different types of locks, and whether the output shaft 63 is rotatable or not can determine being locked or unlocked. When the output shaft 63 is rotatable, unlocking can be performed; the output shaft 63 being non-rotatable is locked.

With reference to FIGS. 2, 5, and 12, in the first embodiment, the output assembly 60 further comprises two hooks 64 configured to engage an anti-theft hole of a portable electronic device and connected to the output shaft 63. Rotations of the output shaft 63 drive the two hooks 64 to unfold or fold. Preferably, in the unlocked state, the user may rotate the output shaft 63 to drive a pushing member 65 to rotate together. The pushing member 65 is mounted via threads to a sleeve 66. Thereby, the rotated pushing member 65 moves toward the two hooks 64 so as to push and unfold the two hooks 64.

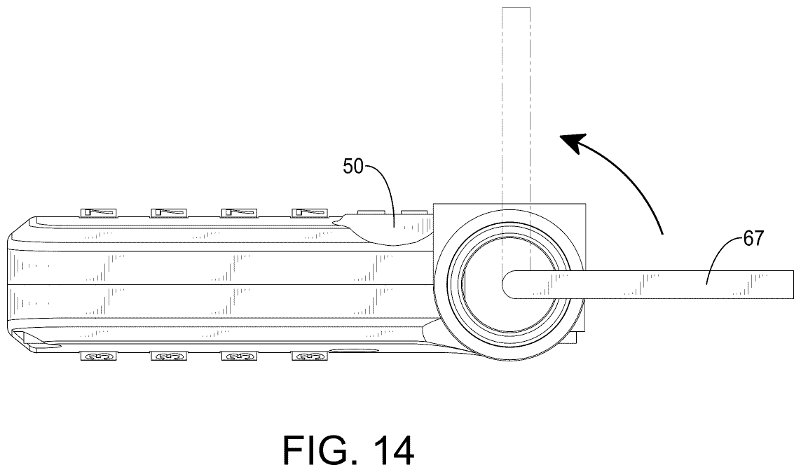

With reference to FIGS. 13 and 14, in the second embodiment, the output assembly 60 further comprises a latch 67 connected to the output shaft 63 and extending along a radial direction of the output shaft 63. In the unlocked state, the user can rotate the output shaft 63 and thereby drive the latch 67 to rotate to different angles so as to serve as a cabinet lock to secure a door. Therefore, the combination lock can be applied on the cabinet lock for lockers at a mall as well as a normal door lock.

The lock type which can utilize the output shaft 63 is not limited to the above-described two types, and the output manner of the output assembly 60 is not limited to the output shaft 63.

In the first and the second embodiments, the operating member 50 is a knob, preferably a knob configured to be rotated via a tool (e.g. a screw driver), but is not limited thereto.

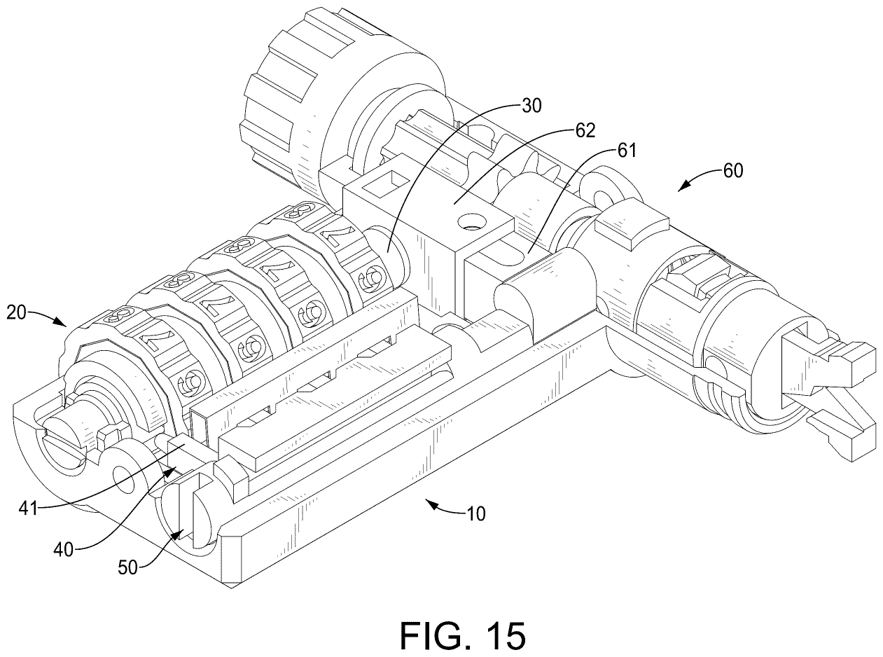

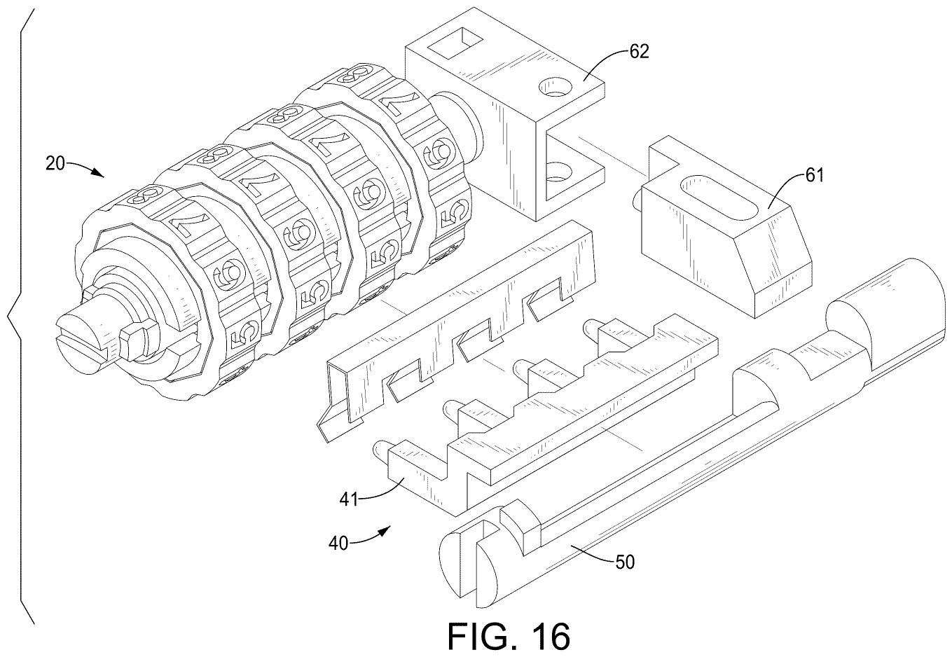

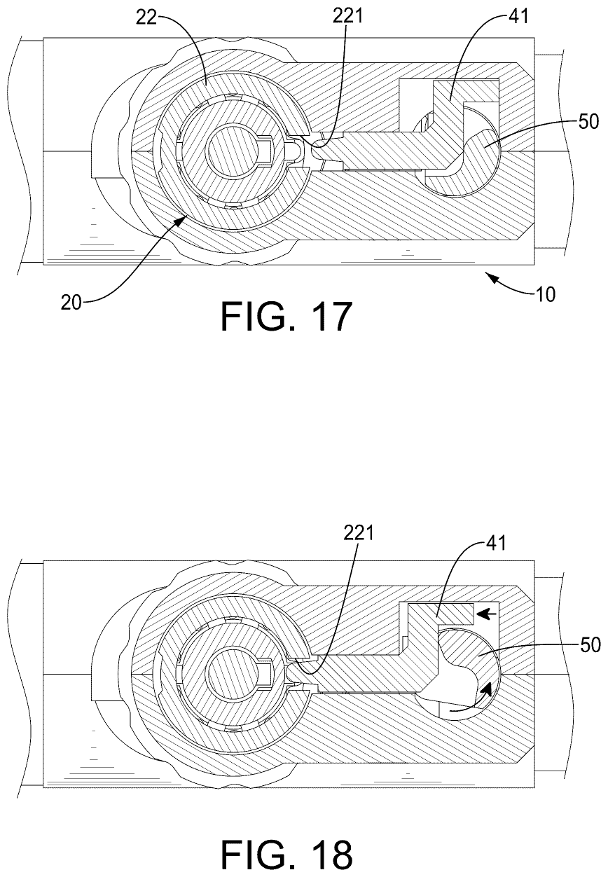

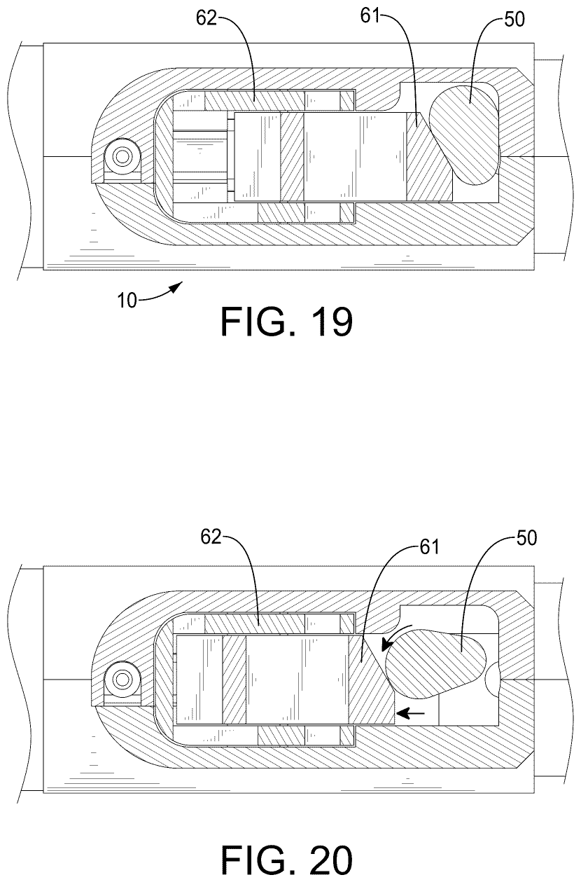

With reference to FIGS. 15 to 20, in the third embodiment, the operating member 50 is a knob located at a position different from those for the first embodiment and the second embodiment. In the third embodiment, with reference to FIGS. 17 and 18, the linkage assembly 40 does not include the direction-changing member 42, and the operating member 50 directly pushes the through member 41 toward the number wheel sets 20 after being rotated. With reference to FIGS. 19 and 20, after being rotated, the operating member 50 also pushes the engaging member 61. Therefore, the third embodiment shares the same effect with the first embodiment.

Additionally, the operating member 50 is not limited to the knob in the aforementioned three embodiments, and the operating member 50 can also push the through member 41 and the engaging member 61 via an inclined surface after being pressed or pushed.

The aforementioned three embodiments constitute the first configuration of the present invention, wherein both the lock rod 30 and the operating member 50 are connected to and control the output assembly 60. In the second configuration of the present invention, the operating member 50 is connected to one of the number wheel sets 20, releases such number wheel set 20 when unlocking, and lets the lock rod 30 move together with the number wheel set 20 so as to switch the output assembly 60 to the unlocked state.

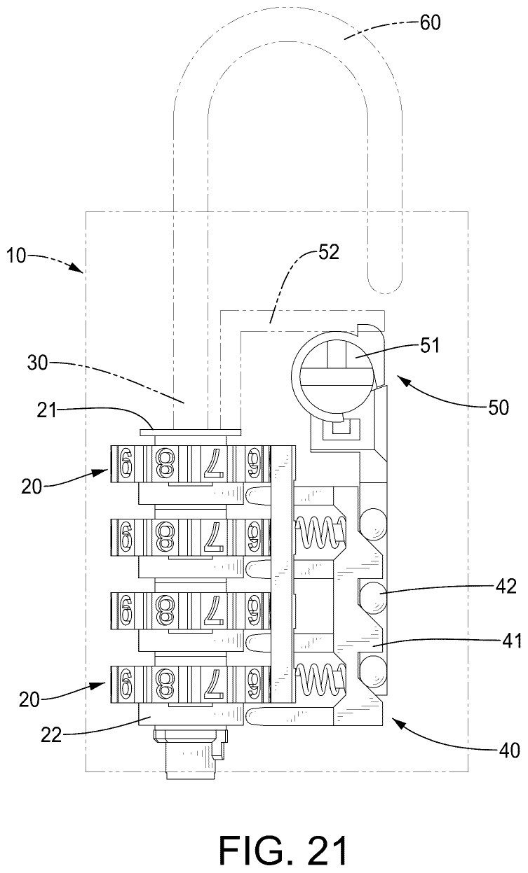

Specifically, with reference to FIGS. 21 to 23, in the fourth embodiment, preferably, the operating member 50 comprises an operating portion 51 and an abutting portion 52. The abutting portion 52 is abutted against the inner sheath 21 of the number wheel set 20 located on an end. Therefore, the inner sheath 21 of the number wheel set 20 cannot move and further restrict the inner sheath 21 of the adjacent number wheel set 20 from moving. As a consequence, the inner sheaths 21 of all the number wheel sets 20 cannot move.

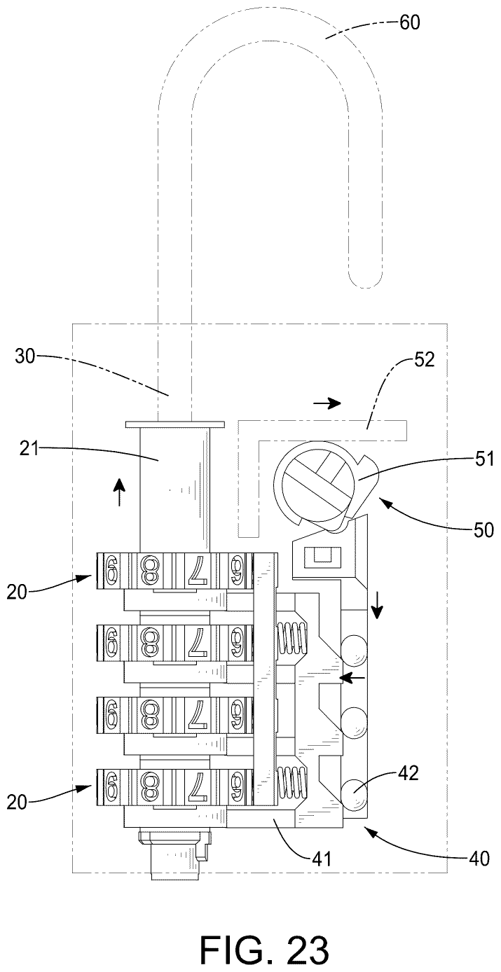

When the number wheel sets 20 are rotated to the master code, the number wheel sets 20 (the outer sheaths 22) allow the linkage assembly 40 (the through member 41) to move or rotate relative to the number wheel sets 20, thereby allowing the operating member 50 (the operating portion 51) to be moved or rotated by the user. After being moved or rotated, the operating portion 51 of the operating member 50 drives the abutting portion 52 to disengage from the inner sheath 21 of said number wheel set 20. As a consequence, the inner sheaths 21 of all the number wheel sets 20 can move. Therefore, even if all the inner sheaths 21 are not rotated to the angles corresponding to the lock rod 30, which means the lock rod 30 cannot move relative to the inner sheaths 21, with reference to FIG. 23, the movable inner sheaths 21 can move along with the lock rod 30.

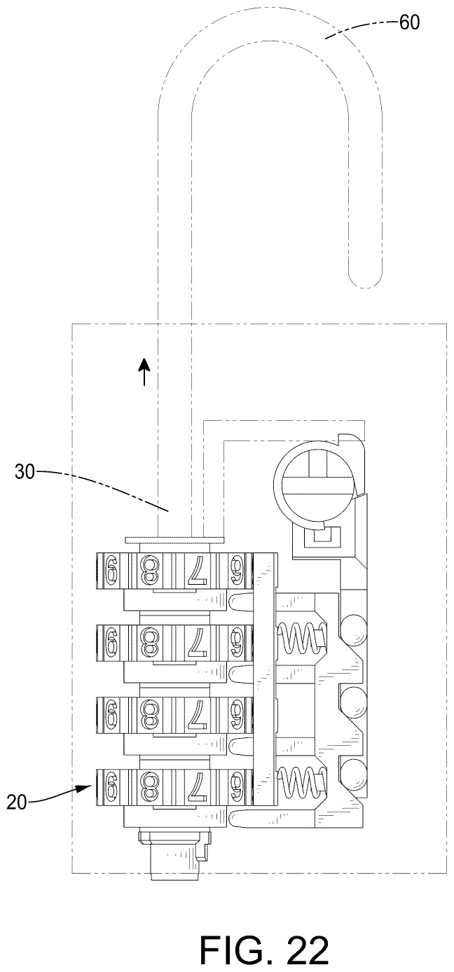

The lock rod 30 can move and switch the output assembly 60 to the unlocked state in either way: with reference to FIG. 22, the number wheel sets 20 are rotated to the user code and the lock rod 30 can disengage from all the inner sheaths 21; or the number wheel sets 20 are rotated to the master code and the lock rod 30 can move along with all the inner sheaths 21.

The engaging member 61 may be connected to an end of the lock rod 30, so when the lock rod 30 moves away from the output shaft 63, the engaging member 61 disengages from the output shaft 63 and the output shaft 63 can be rotated by the user.

Or, the output assembly 60 is connected to an end of the lock rod 30 and the output assembly 60 is bended to be U-shaped, so it can be used as a padlock.

The lock rod 30 can cooperate with different elements to form different types of locks, and whether the lock rod 30 is movable or not can determine being locked or unlocked. When the lock rod 30 is movable, unlocking can be performed; the lock rod 30 being non-movable is locked.

In conclusion, the user generally uses the user code to unlock. When all the number wheel sets 20 are rotated to the user code, the lock rod 30 can move relative to the number wheel sets 20 to switch the output assembly 60 to the unlocked state for unlocking steps. For example, rotate the output shaft 63.

If losing the user code inadvertently, the user may acquire the master code from the management personnel (e.g. of a lock manufacturer or of a mall), and then the output assembly 60 may be switched to the unlocked state as well for unlocking. For example, rotate the output shaft 63 or pull out the output assembly 60.

The present invention thereby has two modes with two different codes for unlocking. The user may unlock with the other code even if forgetting the original code.

Moreover, the shell 10 has an identifier disposed thereon. Thereby, the lock manufacturer may set a unique master code for every individual lock, instead of all locks having the same master code. The user needs to tell the manager the identifier of his lock to acquire the master code exclusively allocated to that lock. Therefore, safety is improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combination lock with dual unlocking modes, and the combination lock comprising:
a shell;
multiple number wheel sets rotatably mounted to the shell and being rotatable by a user;
a lock rod movably mounted in the shell and through the multiple number wheel sets;
a linkage assembly movably or rotatably mounted in the shell and connected to the multiple number wheel sets;
an operating member being operable by the user and connected to the linkage assembly; and
an output assembly connected to the lock rod and the operating member and having an unlocked state and a locked state;
wherein when the multiple number wheel sets are rotated to a user code, the multiple number wheel sets allow the lock rod to move relative to the multiple number wheel sets, so as to switch the output assembly to the unlocked state; and
when the multiple number wheel sets are rotated to a master code, the operating member is moveable or rotatable by the user to move or rotate the linkage assembly relative to the multiple number wheel sets, so as to switch the output assembly to the unlocked state.

2. The combination lock with dual unlocking modes as claimed in claim 1, wherein
each one of the multiple number wheel sets comprises an inner sheath, an outer sheath, and a number wheel;
the inner sheath is disposed through the outer sheath and has an inner notch matching the lock rod; and
the outer sheath is disposed though the number wheel, and the number wheel is configured to rotate the outer sheath and the inner sheath simultaneously;
the outer sheath has an outer notch matching the linkage assembly.

3. The combination lock with dual unlocking modes as claimed in claim 2, wherein
when the multiple number wheel sets are rotated to the user code, the inner notches of the inner sheaths of the multiple number wheel sets are aligned in a straight line; and
when the multiple number wheel sets are rotated to the master code, the outer notches of the outer sheaths of the multiple number wheel sets are aligned in a straight line.

4. The combination lock with dual unlocking modes as claimed in claim 2, wherein for each one of the multiple number wheel sets, the outer notch of the outer sheath is radially disposed on an outer surface of the outer sheath.

5. The combination lock with dual unlocking modes as claimed in claim 1, wherein
the output assembly comprises an engaging member;
when the multiple number wheel sets are rotated to the user code and the lock rod moves, the lock rod drives the engaging member to move, so as to switch the output assembly to the unlocked state; and
when the multiple number wheel sets are rotated to the master code and the operating member is moved or rotated by the user, the operating member drives the engaging member to move, so as to switch the output assembly to the unlocked state.

6. The combination lock with dual unlocking modes as claimed in claim 5, wherein a direction along which the lock rod drives the engaging member to move is non-parallel to a direction along which the operating member drives the engaging member to move.

7. The combination lock with dual unlocking modes as claimed in claim 6, wherein
the output assembly comprises
a base connected to and moving with the lock rod;
the engaging member mounted on the base and configured to move relative to the base; and
a direction along which the engaging member moves relative to the base is non-parallel to a direction along which the lock rod moves;
when the multiple number wheel sets are rotated to the user code and the lock rod moves, the lock rod drives the base and the engaging member to move together, so as to switch the output assembly to the unlocked state; and
when the multiple number wheel sets are rotated to the master code and the operating member is moved or rotated by the user, the operating member makes the engaging member move relative to the base, so as to switch the output assembly to the unlocked state.

8. The combination lock with dual unlocking modes as claimed in claim 5, wherein
the output assembly comprises an output shaft selectively engaged by the engaging member and thereby being non-rotatable;
when the multiple number wheel sets are rotated to the user code, the lock rod is capable of moving away from the output shaft, so as to make the engaging member disengage from the output shaft and make the output shaft rotatable; and
when the multiple number wheel sets are rotated to the master code and the operating member is moved or rotated by the user, the operating member drives the engaging member to move, so as to make the engaging member disengage from the output shaft and make the output shaft rotatable.

9. The combination lock with dual unlocking modes as claimed in claim 8, wherein
the output assembly comprises two hooks configured to engage an anti-theft hole of a portable electronic device and connected to the output shaft; and
the output shaft is configured to drive the two hooks to unfold or fold via rotating.

10. The combination lock with dual unlocking modes as claimed in claim 8, wherein
the output assembly comprises a latch connected to the output shaft and extending along a radial direction of the output shaft; and
the output shaft is configured to rotate the latch to different angles via rotating.

11. The combination lock with dual unlocking modes as claimed in claim 1, wherein the shell has an identifier disposed thereon.

12. The combination lock with dual unlocking modes as claimed in claim 1, wherein the linkage assembly comprises a through member and a direction-changing pushing member;
the through member is movably mounted in the shell, is biased to move toward the direction-changing pushing member, and corresponds to the outer notches of the outer sheaths of the number wheel sets;
the direction-changing pushing member is movably mounted in the shell, is biased to move away from the through member in a direction being non-parallel to a direction along which the through member moves.

13. A combination lock with dual unlocking modes, and the combination lock comprising:
a shell;
multiple number wheel sets rotatably mounted to the shell and being rotatable by a user;
a lock rod movably mounted to the shell and through the multiple number wheel sets;
a linkage assembly movably or rotatably mounted to the shell and connected to the multiple number wheel sets;
an operating member being operable by the user and connected to the linkage assembly and one of the multiple number wheel sets; and
an output assembly connected to the lock rod and having an unlocked state and a locked state;
wherein when the multiple number wheel sets are rotated to a user code, the multiple number wheel sets allow the lock rod to move relative to the multiple number wheel sets, so as to switch the output assembly to the unlocked state; and
when the multiple number wheel sets are rotated to a master code, the operating member is moveable or rotatable by the user to move or rotate the linkage assembly relative to the multiple number wheel sets, so as to allow the multiple number wheel sets and the lock rod to move together and switch the output assembly to the unlocked state.

14. The combination lock with dual unlocking modes as claimed in claim 13, wherein
each one of the multiple number wheel sets comprises an inner sheath, an outer sheath, and a number wheel;
the inner sheath is disposed through the outer sheath and has an inner notch matching the lock rod; and
the outer sheath is disposed though the number wheel and the number wheel is configured to rotate the outer sheath and the inner sheath simultaneously;
the operating member abuts against the inner sheath of one of the multiple number wheel sets;
when the multiple number wheel sets are rotated to the master code and the operating member is moved or rotated by the user, the operating member departs from the inner sheath of the number wheel set, so as to make the lock rod and the inner sheaths of the multiple number wheel sets move together.

15. The combination lock with dual unlocking modes as claimed in claim 13, wherein the output assembly is connected to an end of the lock rod and is bent into a U-shape.
